(19) United States
(12) Patent Application Publication
(10) Pub. No.: US 2014/0060280 A1
(43) Pub. Date: Mar. 6, 2014

(54) PAIR OF SAW BLADES

(71) Applicant: Foshan Nanhai Sun Rising Tools Manufacturing Co., Ltd., (US)

(72) Inventor: Baowen Zhong, Foshan City (CN)

(73) Assignee: Foshan Nanhai Sun Rising Tools Manufacturing Co., Ltd., Foshan City (CN)

(21) Appl. No.: 13/776,487

(22) Filed: Feb. 25, 2013

(30) Foreign Application Priority Data
Aug. 30, 2012 (CN) 201220438033.0

(51) Int. Cl. B23D 61/02

(52) U.S. Cl. CPC B23D 61/025
USPC 83/835

(57) ABSTRACT

The present invention relates to pair of saw blades, comprising a first saw blade and a second saw blade which are coaxial and rotating in opposite directions, wherein each saw blade comprises a circular blade body and saw teeth at periphery of the blade body, a gap is arranged between the first saw blade and the second saw blade, the first blade body of the first saw blade is provided with a protrusion protruding toward the second saw blade, and the second blade body of the second saw blade is provided with a groove corresponding to the protrusion. Therefore, it is difficult to cause interference between the two saw blades even though either of the saw blades is deformed.

### CROSS-REFERENCE TO RELATED APPLICATION(S)

This application claims priority to and the benefit of Chinese Patent Application No. 201220438033.0, filed on Aug. 30, 2012, the disclosure of which is incorporated herein in its entirety by reference.

### TECHNICAL FIELD

The present invention relates to a machining tool, and more specifically, relates to pair of saw blades.

### BACKGROUND TECHNOLOGIES

Compared to a cutting tool with a single saw blade, a cutting tool featuring counter-rotating blades is advantaged in high operating efficiency, by reducing kickback force, park output and vibrations, making it easier to make precision and smooth cuts, and is therefore widely applied. However, in order to enable such a set of Dual Saw Blade to work, it is necessary to leave a proper gap between the two saw blades, so that the heat dissipated while these two saw blades are working and the material powder produced when cutting materials can be discharged from the space.

Chinese Patent Application No. 201020262693 discloses a saw blade adapted for a cutting machine with double saw blades, the saw blade is supposed to solve the problem with the existing double saw blades such as easy transformation and increasing the gap between the blades after certain cutting period, which makes the paired Saw Blade to fail. In this patent, an annular convex rib (the 1^{st} rib) is arranged near the tooth root at one side of the blade body, and an annular convex rib (the 2^{nd} rib) is arranged at the edge of the arbor at one side of the blade body, and the 1^{st} rib and the 2^{nd} rib are homocentric with the arbor of the saw blade. Therefore, there is no space between the core part of the inner saw blade and the outer saw blade, which will not result in a radial deformation caused by the axial displacement of the core part of the saw blade. However, a total of two kinds of convex ribs are arranged in the patent, therefore the convex rib dose to the core part of the saw blade is prone to be contaminated by material powder produced during cutting, which is difficult to be cleaned off.

Chinese Patent Application No. 02812228.3 discloses a kind of paired saw blades, in this patent, a spacer is arranged in the space between two saw blades rotating in opposite directions, and the spacer is connected to the blade body of one saw blade, so that the spacer can support the saw blade and slide along the periphery of the opposite rotating saw blade during cutting. However, the spacer disclosed in this patent application is connected to the saw blade by such means as adhesion; when the saw blade is operating at high speed, heat is generated at the surface of the saw blade, which often causes the spacer to fall off.

### SUMMARY

The present invention provides pair of saw blades, which is advantaged in terms of long service life.

In one aspect, the present invention provides pair of saw blades, comprising a first saw blade and a second saw blade which are coaxial and rotating in opposite directions, wherein each saw blade comprises a circular blade body and saw teeth at periphery of the blade body, a gap is arranged between the first saw blade and the second saw blade, the first blade body of the first saw blade is provided with a protrusion protruding toward the second saw blade, and the second blade body of the second saw blade is provided with a notch corresponding related to the protrusion from the first saw blade.

The protrusion is located at any one or more positions between ¼ of the diameter of the first blade body and the end of the saw teeth, and the second blade body is provided with any one or more notches corresponding to the protrusion(s).

The protrusion is an annular convex rib which is coaxial with the first blade body.

The protrusion is a plurality of bumps distributed at the same or different intervals and forms a ring coaxial with the first blade body.

The protrusion is aligned by at least two convex strips arranged equidistantly and a ring formed by the convex strips is coaxial with the first blade body; alternatively, the protrusion is a convex strip larger than a semicircle and a ring formed by the convex strips is coaxial with first blade body.

Each of the convex strips is in the same shape and of the same size.

The notch is annular and the annular notch is coaxial with the second blade body.

The height of the protrusion related to the first blade body is greater than the depth of the notch of the second blade body.

The width of the notch is greater than that of the protrusion.

Either the first saw blade or the second saw blade is formed integrally.

The benefits of the present invention are shown as follows: the present invention provides pair of saw blades, different from that in the prior art, and a gap is provided between two saw blades arranged side-by-side, which facilitates to dissipate the heat produced while the saw blades are working, and also facilitates to dean the material powder of the cut materials. In addition, in the present invention, a protrusion protruding toward the second blade body is also aligned at the blade body of one saw blade, and a notch corresponding to the protrusion is arranged at the blade body of the other saw blade. The width of the notch is greater than that of the protrusion, and therefore no interference between the two saw blades will be caused even if one of the saw blades is deformed. Moreover, since the notch of the present invention is an annular notch concentric with the second blade body, if the cutting powder comes into the saw blades when working, the cutting powder can be thrown out as long as the saw blades rotate at high speed so that self-cleaning effect can be achieved.

Furthermore, the protrusion and the notch form an orbital rotation operation mode of, which avoids separation of the two saw blades while working or poor coordination between two groups of saw teeth.

### BRIEF DESCRIPTION OF THE DRAWINGS

FIG. 1 is a schematic diagram of pair of saw blades assembled according to the present invention;

FIG. 2 is a schematic diagram showing the longitudinal section when a first saw blade is matched with a second saw blade;

FIG. 3 is a schematic diagram showing the side of the first saw blade toward the second saw blade according to Example 1 of the present invention;

FIG. 4 is a schematic diagram showing the side of the second saw blade toward the first saw blade according to Example 1 of the present invention;

FIG. 5 is a schematic diagram showing the side of the first saw blade toward the second saw blade according to Example 2 of the present invention;

FIG. 6 is a schematic diagram showing the side of the first saw blade toward the second saw blade according to Example 3 of the present invention.

As shown in the drawings, in order to specify the structure of the examples for implementing the present invention. Specific structures and devices are marked in the drawings. However, this is merely for schematic illustration, but not intended to limit the present invention to the specific structures, devices and conditions. Those skilled in the art may adjust and modify these devices and conditions according to the specific requirement, and these adjustments or modifications made are still included in the scope of the appended claims.

### DETAILED DESCRIPTION OF EMBODIMENTS

A set of saw blade provided by the present invention will be described hereinafter in detail combined with drawings and embodiments. In the following descriptions, diverse aspects of the present invention will be described. However, those skilled in the art can use only some or all of the structures/flows of the present invention to implement the present invention. For definiteness of explanation, particular number, configuration and sequence are illustrated, but it is apparent that the present invention can also be implemented without these particular details. In other cases, the well-known features will not be illustrated, in detail to avoid confusing the present invention.

### Example 1

Referring to FIG. 1, pair of saw blades 1 comprises a first saw blade 10 and a second saw blade 20, the two saw blades are coaxially connected side-by-side and move around the same axis 11 in opposite directions. A gap 30 is arranged between the first saw blade 10 and the second saw blade 20.

In this example, the first saw blade 10 and second saw blade 20 are of identically sized. The first saw blade 10 comprises a first blade body 12 which is circular with the axis 11 of the first saw blade as the center. A plurality of saw teeth 13 are arranged at the circular periphery of the first blade body 12 and the total number of the saw teeth is 32 in this example; these saw teeth have the same shape and size; each saw tooth is triangular; a certain space 14 is left between any two adjacent saw teeth, and a cutting edge 15 is at the shortest side 16 of the triangular saw tooth.

The second saw blade 20 comprises a second blade body 22 which is circular with the common axis 11 of the first saw blade and the second saw blade as the center. A plurality of saw teeth 23 are arranged at the circular periphery of the second blade body 22 and the total number of the saw teeth is 32 in this embodiment; these saw teeth have the same shape and size; each saw tooth is triangular; a certain space 24 is left between any two adjacent saw teeth; a cutting edge 25 is at the shortest edge 26 of the triangular saw tooth.

The saw tooth 13 of the first saw blade 10 and the saw tooth 23 of the second saw blade 20 are arranged in the opposite directions, that is, for the first saw blade 10, the shortest edge (shortest side) 16 of the triangular saw tooth 13 is on the left side of the longest edge 17 of the triangular saw tooth, while for the second saw blade 20, the shortest edge 26 of the triangular saw tooth 23 is on the right edge of the longest edge 27.

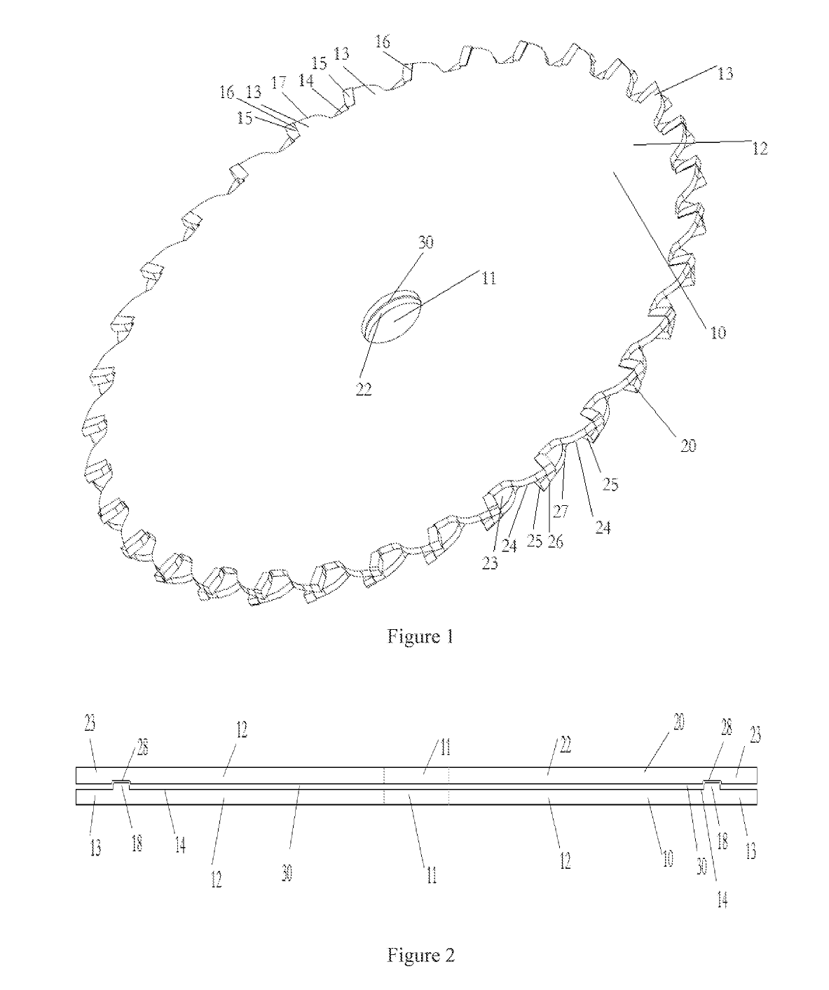

Referring to FIG. 2 which shows the section view when the first saw blade is matched with the second saw blade, the first saw blade 10 is at the bottom, the second saw blade 20 is at the top, and the gap 30 is arranged between the two saw blades, such that the debris of the cut material can be discharged from the gap 30 when the saw blades are cutting, besides, heat can be dispersed from the gap 30 when the two saw blades are operating at high speed.

A protrusion 18 protruding toward the direction of the second saw blade 20 is arranged at the blade body 12 of the first saw blade 10 dose to the saw tooth 13, and a notch 28 corresponding to the protrusion 18 is arranged at the blade body 22 of the second saw blade 20 dose to the saw tooth 23. As seen from FIG. 2, the distance between the protrusion 18 and the side 19 of the first saw blade 10 facing the second saw blade 20, is less than the sum of the depths of the gap 30 and the notch 28, and the width of the notch 28 of the second saw blade 20 is greater than the width of the protrusion 18. Such design is aimed at the case that the pair of saw blades are deformed slightly after using for a long time, and due to designated gap left between the protrusion 18 and the notch, the first saw blade 10 and the second saw blade 20 would not interfere with each other even though the deformation is caused.

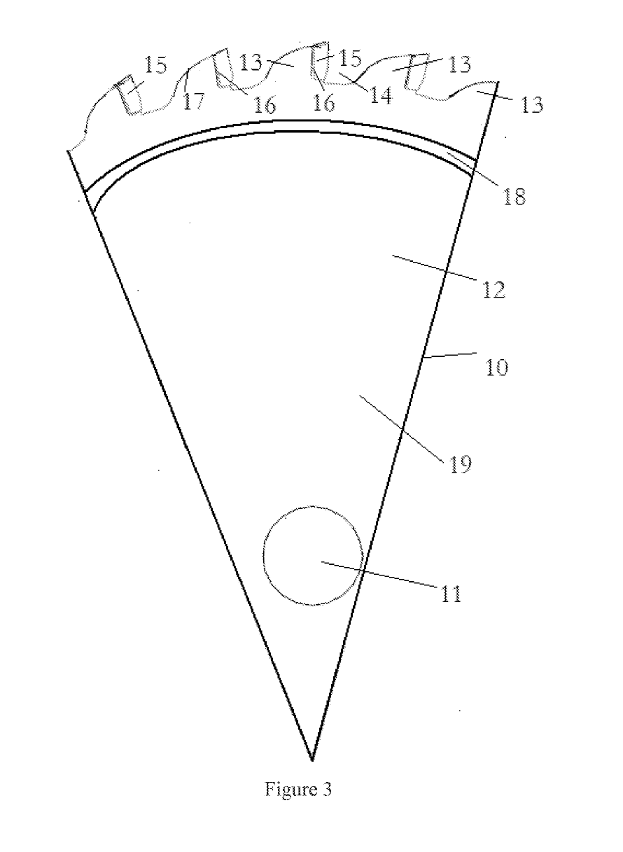

Referring to FIG. 3, which shows the side 19 of the first saw blade 10 facing the second saw blade 20, an annular convex rib (protrusion) 18 is arranged at the first blade body 12 of the first saw blade 10 dose to the saw tooth 13, and the annular convex rib 18 and the first blade body 12 are concentric circles with the same center, that is, the axis 11 of the first saw blade 10 and the second saw blade 20.

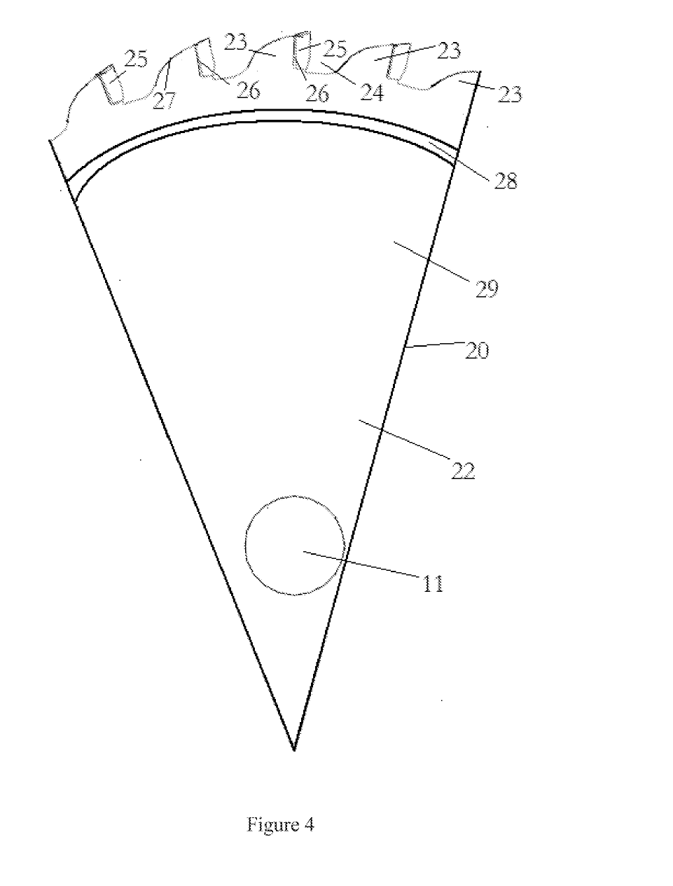

Referring to FIG. 4, which shows the side 29 of the second saw blade 20 facing the first saw blade, an annular notch 28 is arranged at the second blade body 22 of the second saw blade 20 dose to the saw tooth 23, and the annular convex notch 28 and the second blade body 22 are concentric circles with the same center, that is, the axis 11 of the first saw blade 10 and the second saw blade 20.

### Example 2

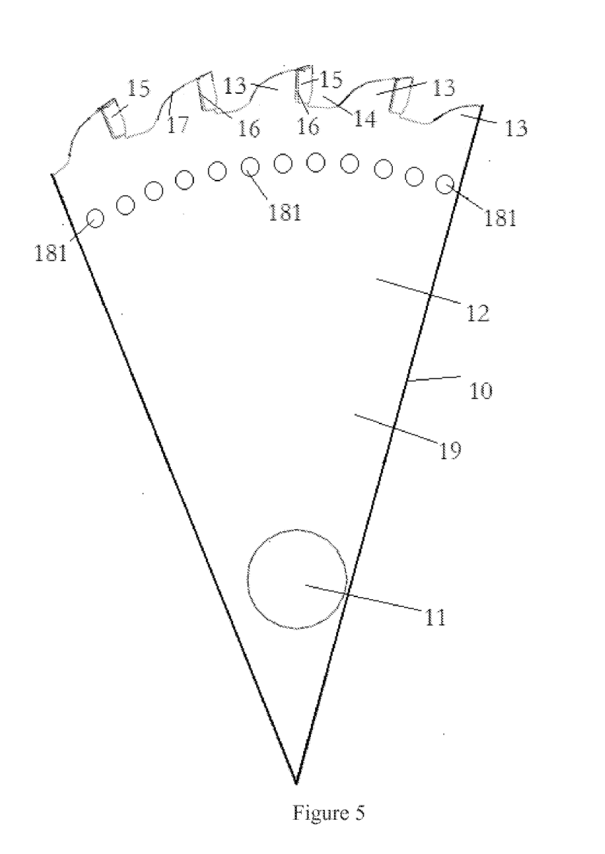

Referring to FIG. 5, this example is similar to Example 1, the difference lies in that a plurality of bumps 181 are arranged at the side 19 of the first blade body 12 of the first saw blade 10 facing the second saw blade 20 in this example, the ring formed by the bumps 181 in series and the first blade body 12 have a common center, that is, the common axis 11 of the first saw blade 10 and the second saw blade 20.

The bumps 181 are circles in the same shape and of the identically sized, and the second saw blade 20 matching with the bumps 181 is shown in FIG. 4. The notch 28 of the second saw blade 20 is shown in FIG. 4. The diameter of the bump 181 is smaller than the width of the notch 28, and the height between the bump 181 and the side 19 of the first blade body 12 facing the second saw blade 20 is smaller than the depth of the notch 28. Such design is aimed at the case that the pair of saw blades are deformed slightly after using for a long time, but due to the space left between the protrusion 18 and the notch, the first saw blade 10 and the second saw blade 20 do not interfere with each other even though the deformation is caused.

### Example 3

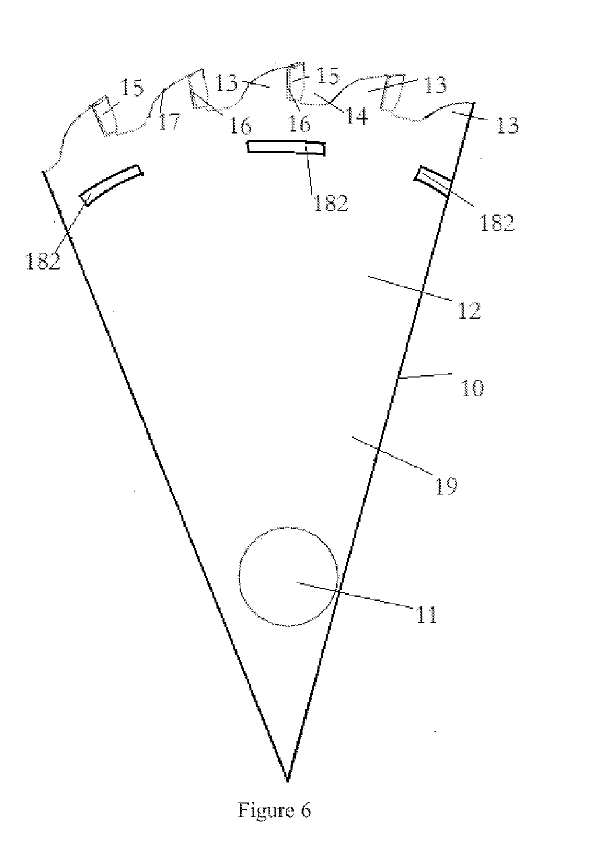

Referring to FIG. 6, this example is similar to Example 1, the difference lies in that a plurality of convex strips 182 are arranged at the side 19 of the first blade body 12 of the first saw blade 10 facing the second saw blade 20 in this example, the ring formed by the convex strips 182 and the first blade body have a common center, that is, the common axis 11 of the first saw blade 10 and the second saw blade 20.

There are at least two the convex strips 182 which are all circular convex strips in the same shape and of the same size and the second saw blade 20 matching with the convex strips 182 is shown in FIG. 4. For the notch 28 of the second saw blade 20, the width of the convex strip 182 is smaller than the width of the notch 28, and the height between the convex strips 182 and the side 19 of the first blade body 12 facing the second saw blade 20 is smaller than the sum of the depth of the gap 30 between the first saw blade 10 and the second saw blade 20 and the depth of the notch 28. Such design is aimed at the case that the pair of saw blades is deformed slightly after using for a long time, but due to the space left between the protrusion 18 and the notch, the first saw blade 10 and the second saw blade 20 do not interfere with each other even though the deformation is caused.

Finally, it should be noted that the embodiments above are merely intended to describe the technical solutions of the present invention, rather than limit the technical method, the present invention can be extended to other modifications, changes, applications and embodiments in terms of application, and it is therefore deemed that all such modifications, changes, applications and embodiments shall be included within the scope of the spirits and teachings of the present invention.

What is claimed is:

1. A pair of saw blades, comprising:
a first saw blade and a second saw blade which are coaxial and rotating in opposite directions, wherein:
each saw blade comprises a circular blade body and saw teeth at periphery of the blade body,
a gap is arranged between the first saw blade and the second saw blade,
the first blade body of the first saw blade is provided with a protrusion protruding toward the second saw blade, and
the second blade body of the second saw blade is provided with a notch corresponding to the protrusion.

2. The pair of saw blades according to claim 1, wherein the notch is annular and the annular notch is coaxial with the second blade body.

3. The pair of saw blades according to claim 1, wherein the height of the protrusion relative to the first blade body is greater than the depth of the notch of the second blade body.

4. The pair of saw blades according to claim 1, wherein the width of the notch is greater than that of the protrusion.

5. The pair of saw blades according to claim 1, wherein the first saw blade or the second saw blade is formed integrally.

6. The pair of saw blades according to claim 1, wherein the protrusion is located at any one or more positions between ¼ of the diameter of the first blade body and the end of the saw teeth, and the second blade body is provided with any one or more notches corresponding to the protrusion(s).

7. The pair of saw blades according to claim 6, wherein the protrusion is an annular convex rib which is coaxial with the first blade body.

8. The pair of saw blades according to claim 6, wherein the protrusion is a plurality of bumps distributed at the same or different intervals and a ring formed by the bumps is coaxial with the first blade body.

9. The pair of saw blades according to claim 6, wherein the protrusion is at least two convex strips arranged equidistantly and a ring formed by the convex strips is coaxial with the first blade body.

10. The pair of saw blades according to claim 9, wherein the respective convex strips are in the same shape and of the identically sized.

11. The pair of saw blades according to claim 6, wherein the protrusion is a convex strip larger than a semicircle and a ring formed by the convex strips is coaxial with first blade body.

12. The pair of saw blades according to claim 11, wherein the respective convex strips are in the same shape and of the identically sized.

13. The pair of saw blades according to claim 6, wherein the notch is annular and the annular notch is coaxial with the second blade body.

14. The pair of saw blades according to dam 6, wherein the height of the protrusion relative to the first blade body is greater than the depth of the notch of the second blade body.

15. The pair of saw blades according to claim 6, wherein the width of the notch is greater than that of the protrusion.

16. The pair of saw blades according to claim 6, wherein the first saw blade or the second saw blade is formed integrally.
